(19) United States
(12) Patent Application Publication
(10) Pub. No.: US 2024/0174409 A1
(43) Pub. Date: May 30, 2024

(54) Sealed Storage Box with Push Closure

(71) Applicant: Michael Peretz Ben-Asher, Tel Aviv (IL)

(72) Inventor: Michael Peretz Ben-Asher, Tel Aviv (IL)

(21) Appl. No.: 18/106,496

(22) Filed: Feb. 7, 2023

Related U.S. Application Data
(60) Provisional application No. 63/428,489, filed on Nov. 29, 2022.

(51) Int. Cl. B65D 43/02

(52) U.S. Cl. CPC B65D 43/022; B65D 2543/00101; B65D 2543/00231; B65D 2543/00935; B65D 2543/0099

(57) ABSTRACT

A storage box that includes a container, a lid and a circular seal. The lid includes a bottom part, a top part, a bottom cog-wheel part with sloping teeth, a spring, a snap part with stopping members, two lever bodies, a top cog-wheel with sloping pushing teeth, and a push button handle. The bottom part includes an indent for containing the spring and oriented holes for the snap part snaps. The top part includes the top button handle, the top cog-wheel part, the two lever bodies, and the bottom cog-wheel. The spring is positioned inside the indentation, the top part is assembled on the bottom part, the bottom cog-wheel is connected to the top cog-wheel in a way that enables a rotational movement between them and disables a relative vertical movement. The lid is in a retracted close position or in an extended open position.

### TECHNICAL FIELD

The present invention refers to a sealed storage box.

### Background Art

It is very common to use sealed storage boxes for food storage and other materials, and the market is hungry for new and efficient boxes of this kind. The present invention discloses a new and innovative sealed storage box.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts the storage box (10) that includes the container and the lid.

FIG. 2 depicts the storage box (10) in the extended open position.

FIG. 3 depicts the container (20).

FIG. 4 depicts a top view of the lid (30).

FIG. 5 depicts a bottom view of the lid (30).

FIG. 6 is an exploded view of the lid (30) and its parts with the circular seal.

FIG. 7 is an exploded view of the bottom part (31) and its parts.

FIG. 8 depicts the bottom part (31) and its parts assembled.

FIG. 9 depicts the snap part (33).

FIG. 10 is an exploded view of the top part (32) and its parts.

FIG. 11 depicts the top part (32) and its parts assembled.

FIG. 12 depicts the push button handle part (38).

FIG. 13 depicts the bottom cog-wheel part (35).

FIG. 14 depicts the top cog-wheel part (37).

FIG. 15 depicts the 2 lever bodies (36).

FIG. 16 depicts a cut view of the entire lid (30) assembly, step 1.

FIG. 17 depicts a cut view of the entire lid (30) assembly, step 2.

FIG. 18 depicts a cut view of the entire lid (30) assembly, step 3.

FIGS. 19A and 19B depict the lid in the retracted open position.

FIGS. 20A and 20B depict the lid in the extended closed position.

### THE INVENTION

The main object of the present invention is to provide a storage box (10) that includes a container (20) that is designed to contain food or other materials that the user wants to store, a lid (30) that is designed to cover and seal the top opening of the container and a circular seal (40).

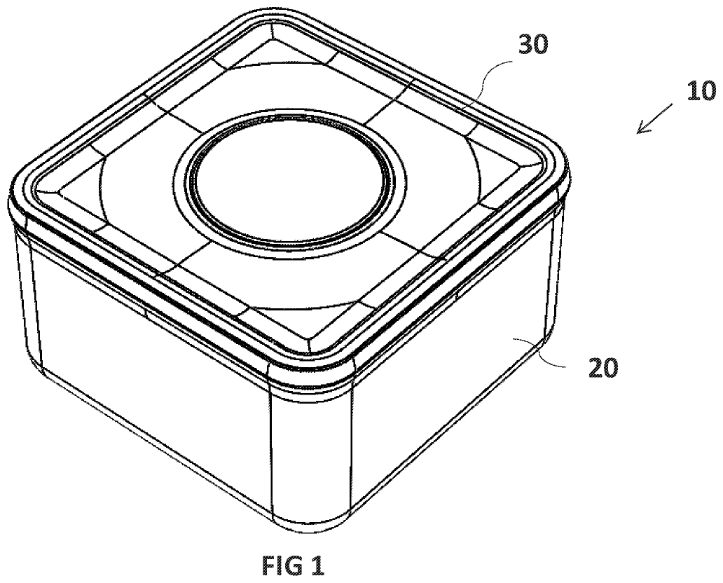

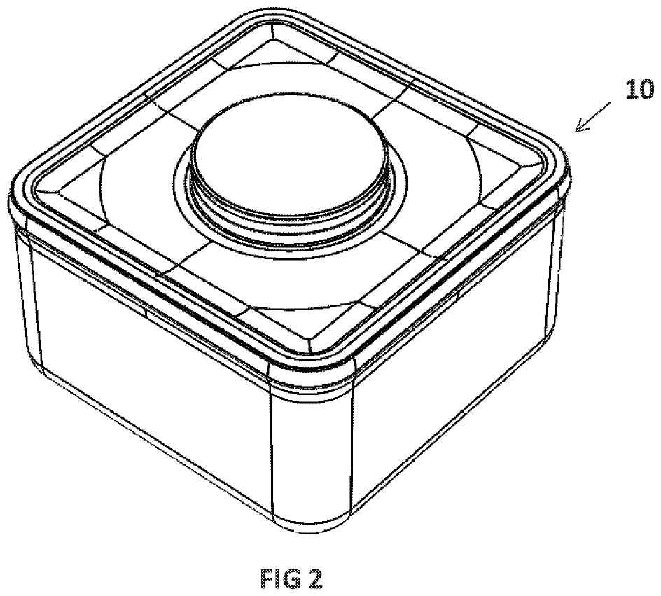

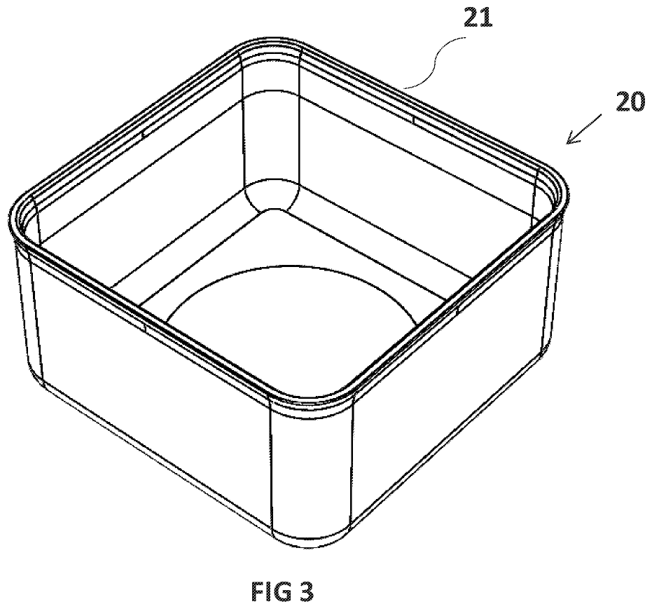

The container (20) is designed with a peripheral lip (21) on which the lid (30) is designed to be positioned. FIG. 1 depicts the storage box (10) that includes the container (20) and the lid (30). FIG. 2 depicts the storage box (10) in an open position. FIG. 3 depicts the container (20).

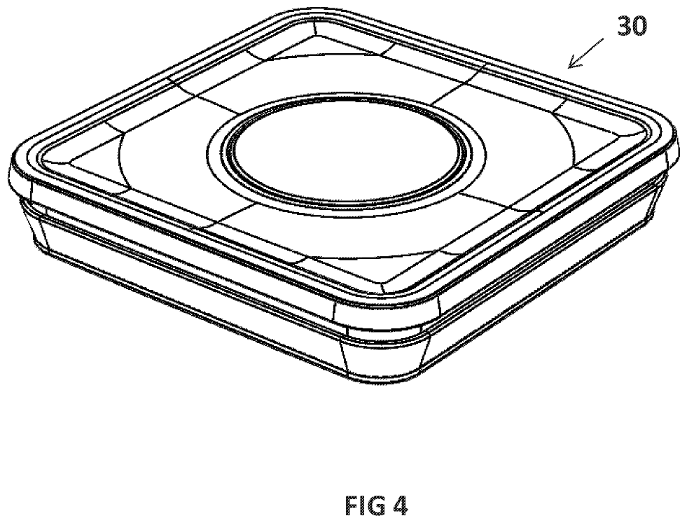

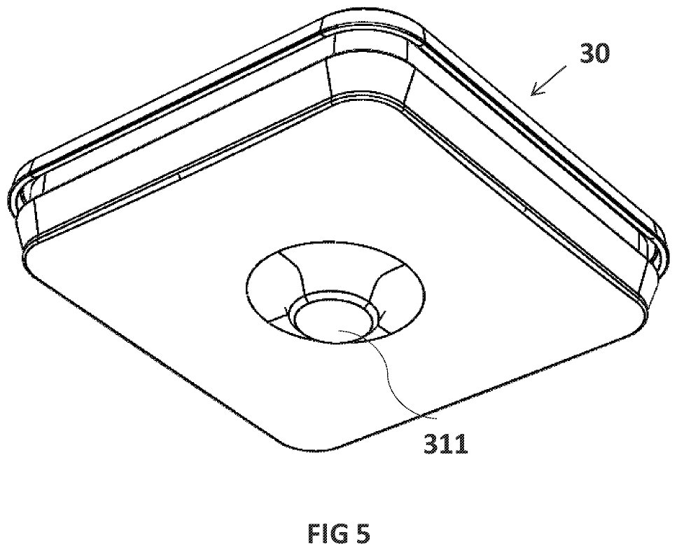

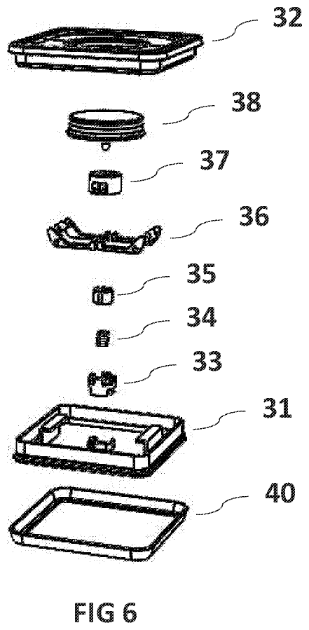

The lid (30) includes a bottom part (31), a top part (32), a snap body (33), a spring (34), a bottom cog-wheel (35), two lever bodies (36), a top cog-wheel (37) and a push button (38). FIG. 4 depicts a top view of the lid (30) and FIG. 5 depicts a bottom view of the lid (30). FIG. 6 is an exploded view of the lid (30) and its parts with the circular seal (40).

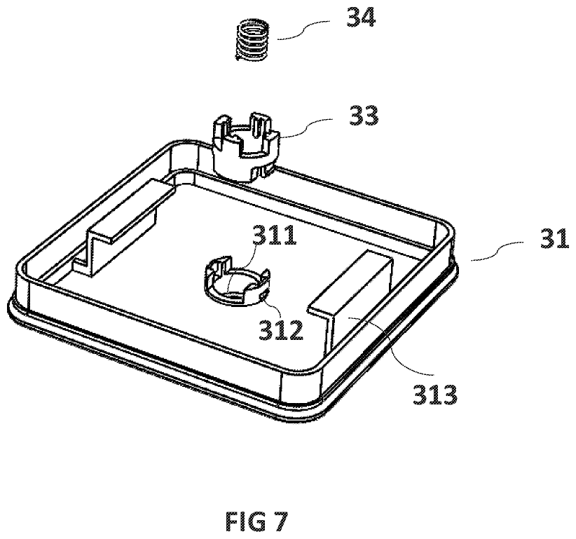

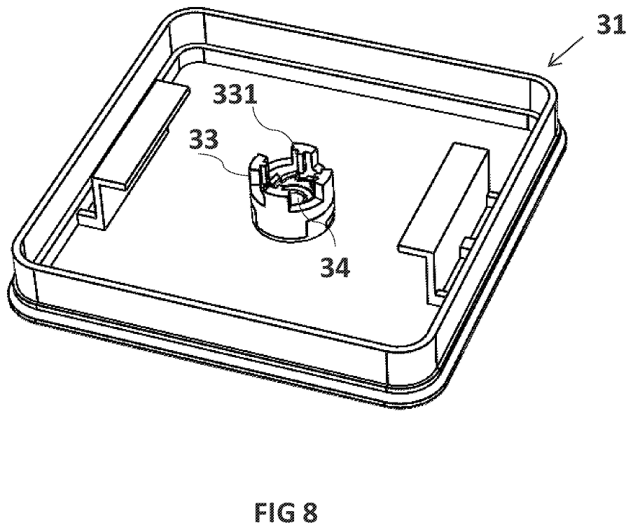

The bottom part (31) includes an indentation at the base (311) that is adapted to contain the spring (34). The snap part (33) is connected by inserting tabs into side oriented holes at the bottom part (312). FIG. 7 depicts assembly explosion view of the bottom part (31), the snap part (33) and the spring (34), FIG. 8 depicts the bottom part (31) assembled when the spring (34) is positioned in the indentation at the base (311) and the snap part (33) is snaped to its oriented place (312).

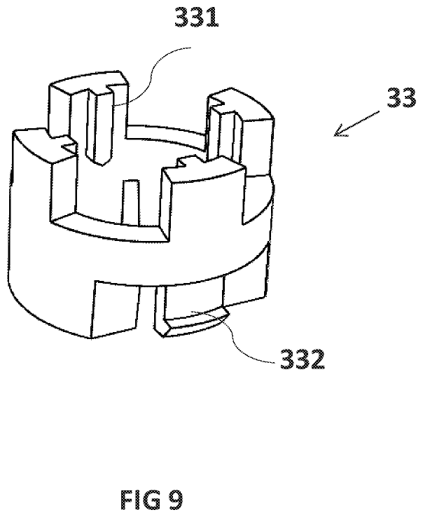

The snap part (33) as showed in FIG. 9 includes 4 or more stopping members (331) and 2 or more snapes (332).

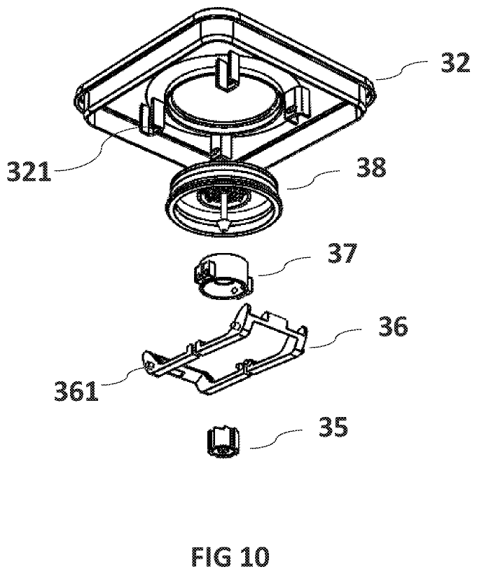

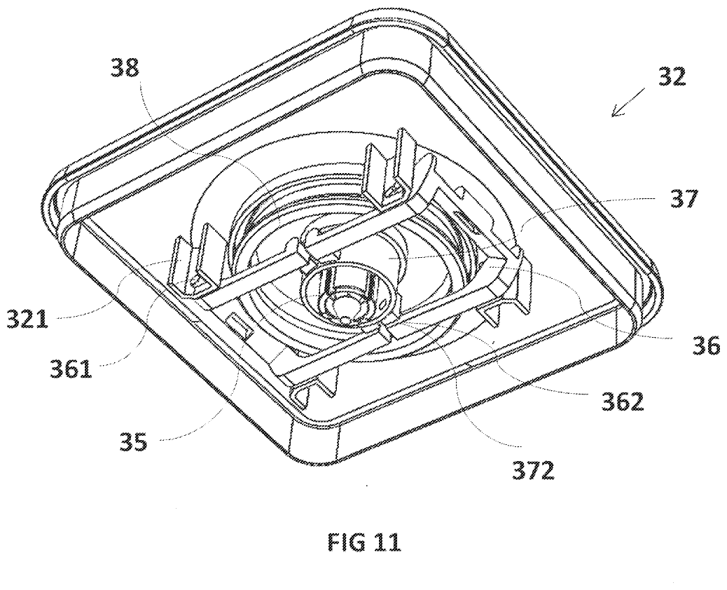

The top part (32) includes 4 walls (321) that are adapted to contain the 2 lever bodies (36) after inserting the push button (38) the top cog-wheel (37) connected to the 2 lever bodies (36) and the bottom cog-wheel part (35). FIG. 10 depicts assembly explosion view of the top part (32), the top button (38) the top cog-wheel part (37) the 2 lever bodies (36) and the bottom cog-wheel part (35), FIG. 11 depicts the top part (32) assembled when the 2 lever bodies axis (362) are connected to the top cog-wheel part (372) and axis (361) are connected to the top part (321) both are connected to the push button (38) with the bottom cog-wheel part (35).

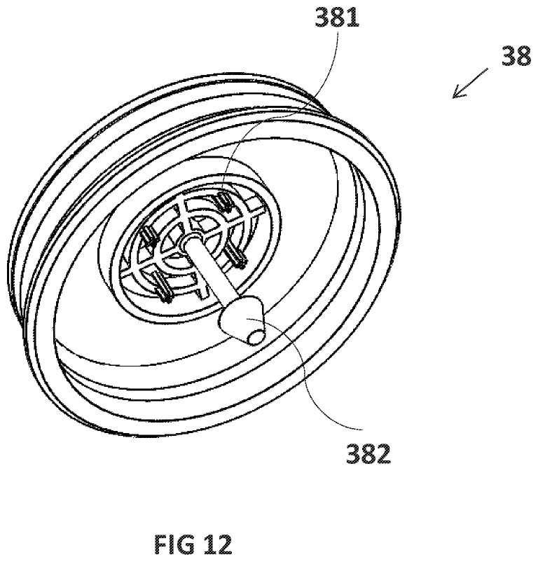

The push button (38) as showed in FIG. 12 includes 4 or more bosses (381) to be inserted to the top cog-wheel part-oriented holes (373) and a main snap (382) to connect the top cog-wheel part (37) the 2 lever bodies (36) and the bottom cog-wheel part (35).

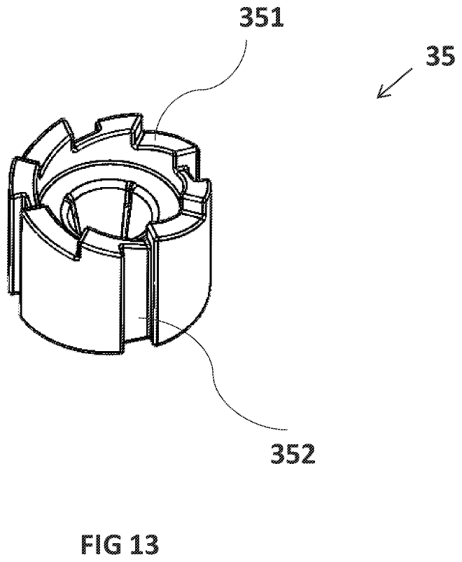

The bottom cog-wheel part (35) as showed in FIG. 13 includes several indents (352) but it can have more or less, and includes 8 sloping teeth (351) but it can have more or less.

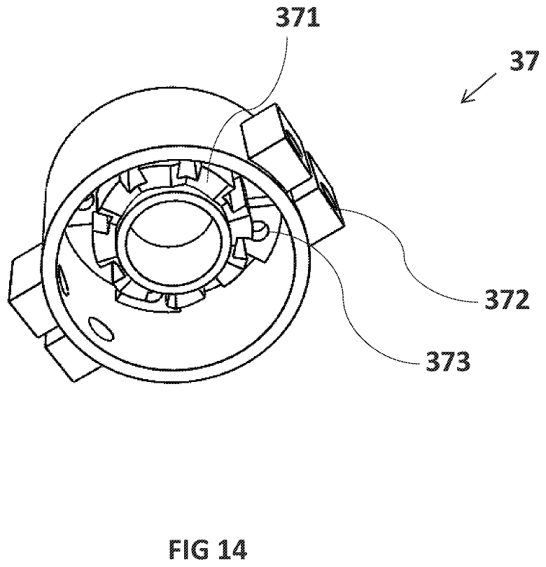

The top cog-wheel part (37) as showed in FIG. 14 includes 8 sloping pushing teeth (371) but it can have more or less, 4 axis holes (372) and 4 holes (373) oriented for the push button handles bosses but it can have more or less. The top cog-wheel is inserted to the push button handle (38) through its snap (382) after being connected (372) axially to the lever bodies center rods (362).

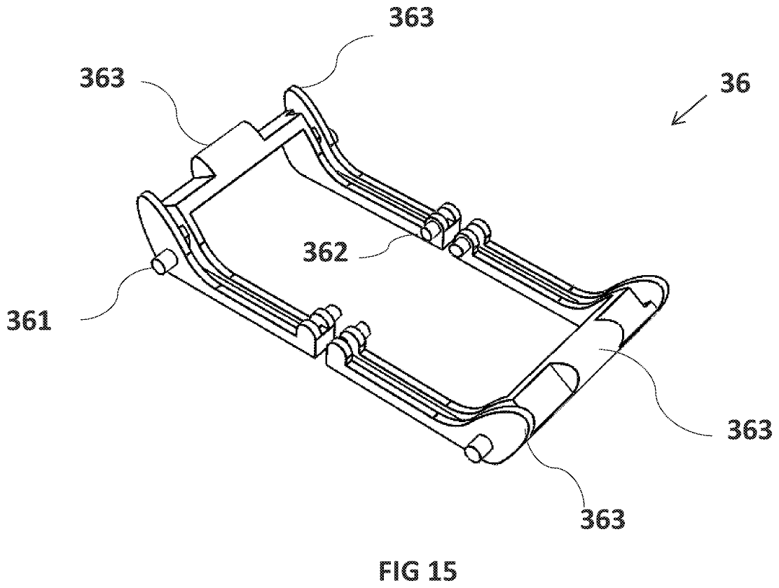

The 2 lever bodies (36) as showed in FIG. 15 includes two center rods for each body (362) for axially connecting the each lever body 36 to the top cog-wheel part-oriented holes (372) and two edge rods (361) for each body (361) for axially connecting the body 36 to the walls (321) of the top part (32).

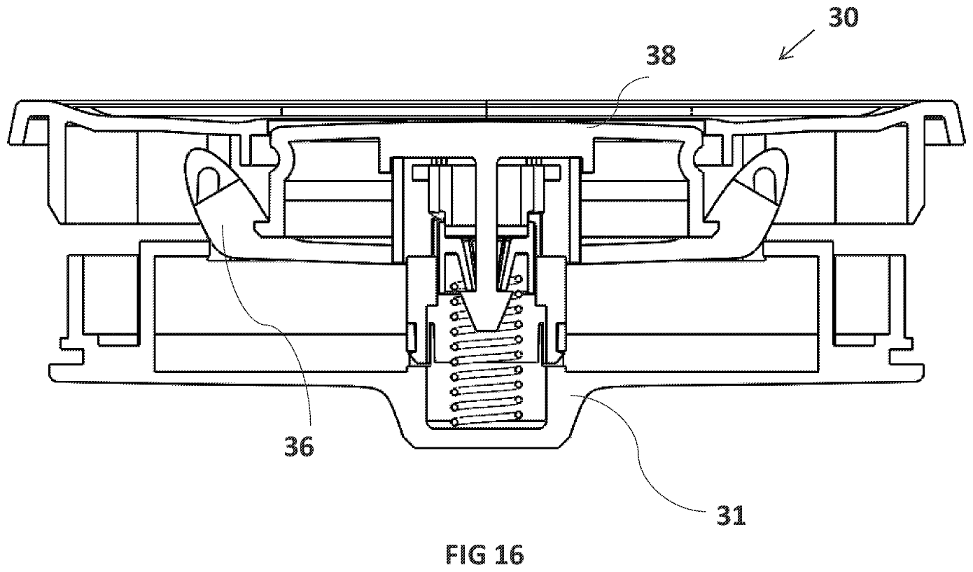

FIG. 16 depicts a cut view of the lid (30) when assembling its entire parts together—step 1 (assembly 1 and assembly 2). In order to assemble the entire lid the push button (38) is pushed hard downward, making the 2 lever bodies (36) pressed upward.

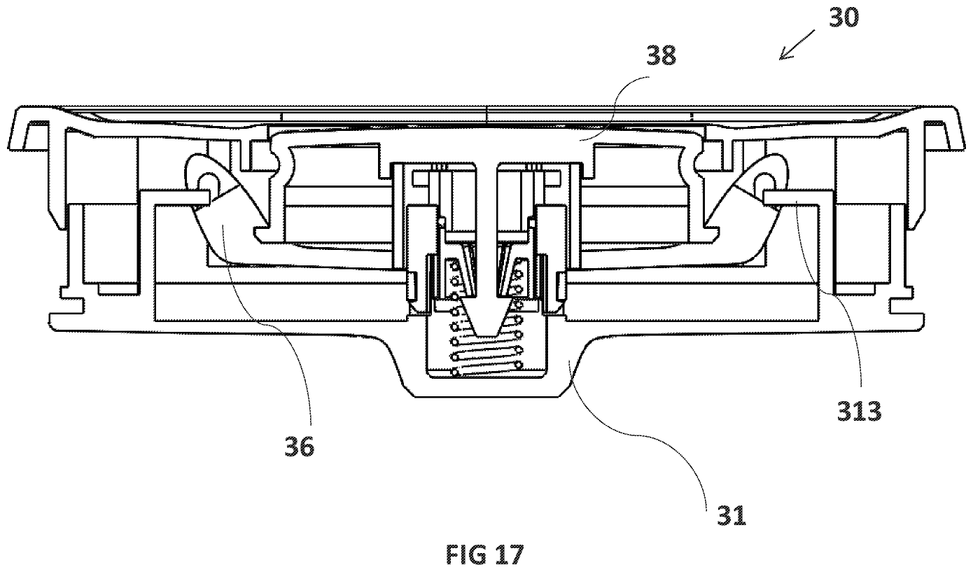

FIG. 17 depicts a cut view of the lid (30) when assembling its entire parts together—step 2 (assembly 1 and assembly 2). While the push button (38) is being pushed hard downward, and the 2 lever bodies (36) are being pressed upward, the 2 lever bodies (36) are pressing sideways the oriented walls (313) of the bottom part (31).

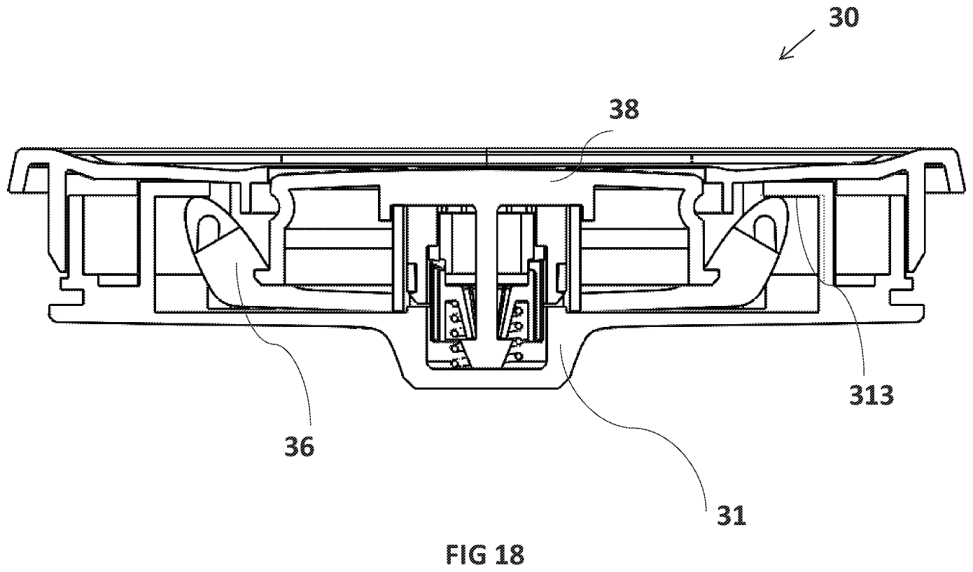

FIG. 18 depicts a cut view of the lid (30) when assembling its entire parts together—step 3 (assembly 1 and assembly 2). while the push button (38) is being pushed hard downward, and the 2 lever bodies (36) are being pressed upward, assembly 1 is inserted to assembly 2, the 2 lever bodies (36) passed through the bottom part's (31) oriented walls (313) and now are locked in those walls. The lid is now assembled.

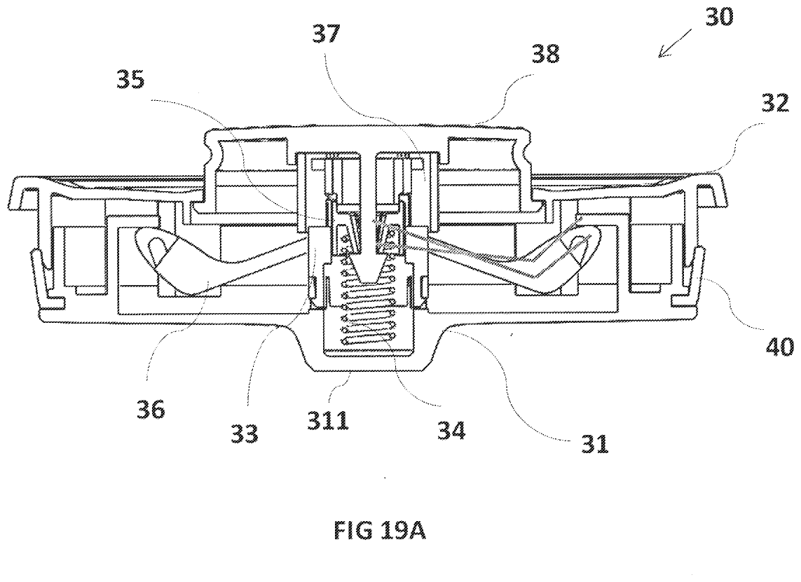

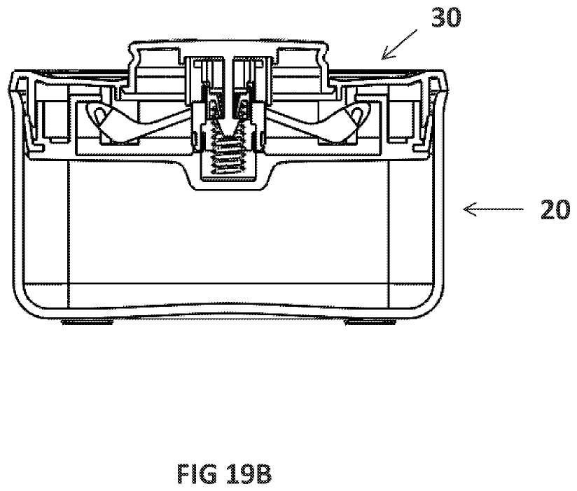

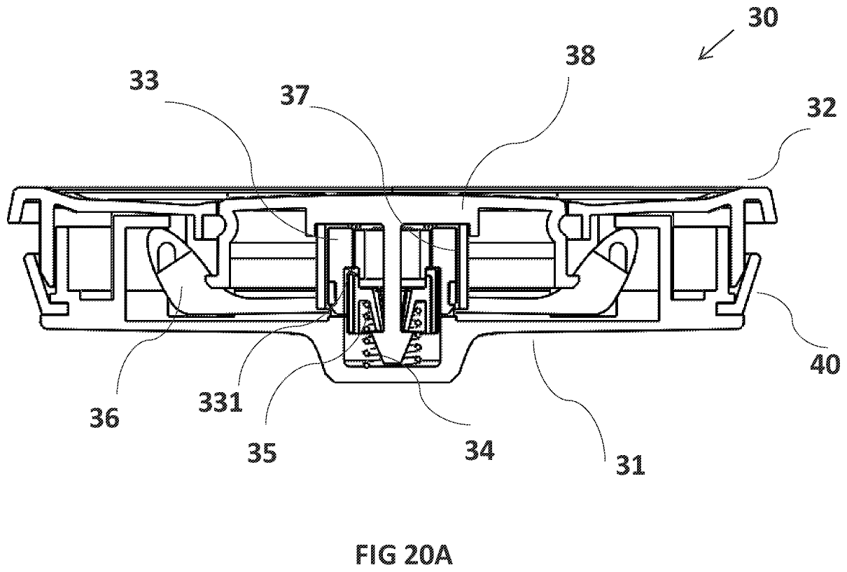

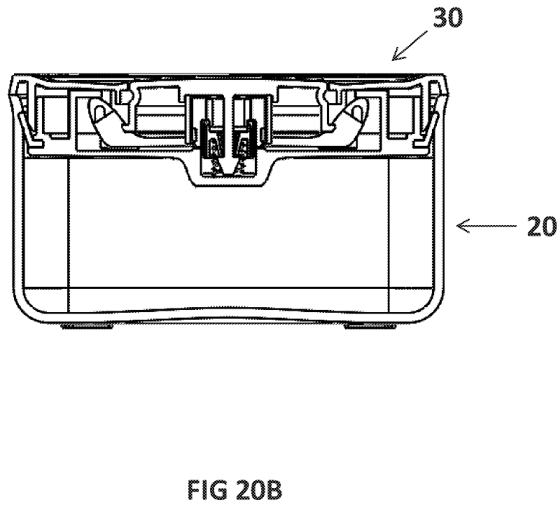

FIGS. 19A, 19B, 20A and 20B depict a view of the lid (30) when it is in a retracted close position or in an extended open position. Assembly 1 is connected to assembly 2. The sloping teeth (351) of the bottom cog-wheel body (35) are combined with the sloping pushing teeth (371) of the top cog-wheel part (37). In the drawings that are attached to the present application the top cog-wheel part (37) and the bottom cog-wheel part (35) includes 8 sloping pushing teeth (371 & 351) but it can have more or less.

The stopping members (331) of the snap part (33) together with the sloping teeth (351) of the bottom cog-wheel body (35), the spring (34) and the sloping pushing teeth (371) of the top cog-wheel part (37) connected to the push button (38) serve in fact as a retract extend mechanism that works in general as the known retractable ballpoint pen mechanism. In action, the bottom cog-wheel body (35) rotates and slides up and down, the top cog-wheel part (37) with the sloping pushing teeth (371) does not rotate but only slides up and down and serves as a plunger, making the 2 lever bodies (36) push and release the bottom part (31) making it also move up and down and change the pressure on the seal part (40) which is being pressured and seals the box or is being released and makes the box open.

The way of assembling the parts of the lid (30) together with the circular seal (40): Assembly 1: The snap part (33) is being snaped (332) to the bottom part-oriented holes (312) and the spring (34) is to be inserted inside the base indentation (311) of the bottom part (31).

Assembly 2: The 2 lever bodies axis (362) is to be inserted to the oriented holes (372) of the top cog-wheel part (37) then they are both to be inserted to the top push button handle snap (382), then the bottom cog-wheel part (35) is to be inserted to the push button handle snap (382) so that the sloping pushing teeth (371) are touching the sloping teeth (351) of the bottom cog-wheel part (35). Next the push button handle (38) is to be inserted to the top part's (32) of the hole from beneath and the 2 lever bodies axis (361) is to be inserted to the top part's-oriented walls (321).

Assembling the entire lid (connecting assembly 1 & 2 together) will happen by pushing hard on the push button handle (38) making the 2 lever bodies (36) lift and then the bottom cog-wheel (35) can be inserted through the stopping members (331) of the snap part (33), the 2 lever bodies (36) are pressing the bottom part's (31) oriented walls (313) sideways and slid down till they are locked within those walls. Once inserted, the pressure is to be released from the top button handle (38) and the entire lid is connected. The top part and the bottom part may include means that enable to connect them together in a way that enables a relative movement up and down between them. After that, assembling the circular seal (40) around the lid (30). The bottom cog-wheel part (35) is connected to the top cog-wheel part (37) in a way that enables a rotational movement between them but not a relative vertical movement.

Retracted close position and extended open position of the lid (30): When the slopping teeth (351) of the bottom cog-wheel part (35) are under the stopping members (331) of the snap part (33) as illustrated for example in the drawings, then the bottom part (31) is tight upward to the top part (32) due to the fact that the bottom cog-wheel part (35) is ‘locked’ under the stopping members (331) making the 2 lever bodies (36) push upward the bottom part (31). The seal (40) then is being pressured against the container (20) as illustrated in the drawings, and this is the retracted close position of the lid (the box is closed and sealed). When the slopping teeth (351) of the bottom cog-wheel part (35) are not under the stopping members (331) of the snap part (33) as illustrated for example in the drawings, then the bottom part (31) is released downward away from the top part (32) due to the fact that the bottom cog-wheel part (35) is no longer ‘locked’ under the stopping members (331) and so the 2 lever bodies (36) pressure is released, then the circular seal (40) is being released as well and this is the extended open position of the lid (the box can be opened).

Whenever the user pushes down the push button handle (38) these positions are changed. For example, when the lid is in the extended open position and the user pushes down the push button handle (38) then the top cog-wheel part (37) push down the spring and the bottom cog-wheel part (35) makes one rotational step so that the slopping teeth (351) are now under the stopping members (331) and the lid is now come to the retracted close position, and so on.

The way that parts 33 and 34 are assembled and connected together to part 31 is explained above and the same to parts 38, 37, 36 and 35 as they are assembled and connected together and to part 32. We would like to emphasize that the edges 363 of the two lever bodies 36 are axially connected by the edges rods 361 with the walls 321 of the top part 32 and the center rods 362 of the bodies 36 are axially connected to the holes 372 of the top cog-wheel. The edges 363 of the bodies 36 are locked under the oriented walls 313 of the bottom part 31. In this way, the bodies 36 disable the separations of the top part 32 from the bottom part 31 due to the fact the their centers are connected to part 37 (and indirectly to the top part) and their edges are locked under part 313 of the bottom part 31, preventing the top part to be pulled out. And in addition to that, when the centers of the bodies 36 are pushed down (when pressing on the button 38 and the part 37, then their edges 363 push up the walls 313 and by that pushing up the bottom part 31 toward the top part to the closed position.

What we claim is:

1. A storage box that comprises a container that is designed to contain materials, a lid that is designed to cover the top lip of the container and a circular seal that is designed to enclose the lid;
wherein the lid includes a bottom part, a top part, a bottom cog-wheel part with sloping teeth, a spring, a snap part with stopping members, two lever bodies, a top cog-wheel with sloping pushing teeth and a push button handle;
wherein said bottom part includes an indent that is adapted to contain the spring and includes oriented holes for the snap part snaps; wherein the top part includes the top button handle, the top cog-wheel part with the sloping pushing teeth, the two lever bodies, and the bottom cog-wheel with its slopping teeth;
wherein said spring is designed to be positioned inside the indentation base of the bottom part; wherein the top part with all of its connected parts is designed to be assembled on the bottom part with its spring and snap part connected; wherein the bottom cog-wheel part is designed to be connected to the top cog-wheel part in a way that enables a rotational movement between them and disable a relative vertical movement; wherein the lid is designed to be in a retracted close position or in an extended open position, said positions can be changed whenever a user push down the push button handle.
